(19) United States
(12) Patent Application Publication
(10) Pub. No.: US 2006/0145836 A1
(43) Pub. Date: Jul. 6, 2006

(54) Antitheft system

(76) Inventor: Hideto Miyazaki, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/545,273

(22) PCT Filed: Oct. 27, 2004
(86) PCT No.: PCT/JP04/15938

§ 371 Date: Aug. 11, 2005

(30) Foreign Application Priority Data
Dec. 22, 2003 (JP) 2003-425232

(51) Int. Cl. G08B 1/08

(52) U.S. Cl. 340/539.1

(57) ABSTRACT

An anti-theft system includes an engine control unit 4 for starting an engine 2 in response to the on operation of an engine key 5 only when an engine start enabling signal is supplied thereto, portable communication equipment 7 which is used for short-distance wireless communications, and to which peculiar ID information is provided, and vehicle-mounted communication equipment 6 having an ID information storage unit 6a for registering the peculiar ID information provided to the portable communication equipment 7 thereinto, for acquiring the ID information from the portable communication equipment 7 via short-distance wireless communications regardless of whether the on operation of the engine key has been carried out, and for stopping the supply of the engine start enabling signal to the engine control unit 4 when the acquired ID information does not match with the ID information registered into the ID information storage unit 6a.

### FIELD OF THE INVENTION

The present invention relates to an anti-theft system. More particularly, it relates to a technology for implementing theft prevention using portable communication equipment.

### BACKGROUND OF THE INVENTION

Conventionally, a security system for vehicles which protects a vehicle from theft by identifying a person who is allowed to use the vehicle (referred to as an “authorized vehicle user” from here on) using portable communication equipment is known (for example, refer to patent reference 1). In this security system for vehicles, the same ID information as ID information given to the portable communication equipment which the authorized vehicle user is having is registered into a memory in vehicle-mounted equipment. When a main power supply for vehicles is turned on by an ignition switch, the vehicle-mounted equipment carries out short distance wireless communications with the portable communication equipment and then checks to see whether the ID information stored therein matches with that given to the portable communication equipment. When determining that the ID information stored therein does not match with that given to the portable communication equipment, the vehicle-mounted equipment outputs an alarm signal indicating an instruction for prohibiting an engine ECU from staring the engine to the engine ECU and also sends alarm information, byway of a vehicle-mounted communication terminal which can carry out long distance communications, to the portable communication equipment which the authorized vehicle user is having.

Furthermore, when the portable communication equipment which the authorized vehicle user is having receives the alarm information, the related art security system for vehicles can perform a driving prohibition control operation of switching the vehicle to a driving impossible state in which the vehicle cannot be driven on condition that the vehicle is stopping. When a proper user does not exist in an area where the vehicle-mounted communication terminal carries out short distance communications, the related art security system can enable a door locking mechanism for vehicles to carry out a locking operation through a locking/unlocking device. When receiving an acknowledge request signal from the portable communication equipment which the authorized vehicle user is having, the related art security system answers a status signal indicating whether the vehicle is locked or unlocked back to the portable communication equipment through the vehicle-mounted communication terminal. Then, when the authorized vehicle user recognizes that he or she has forgotten to lock the vehicle, he or she can manipulate the portable communication equipment to make it send a locking command signal to the vehicle-mounted communication terminal and to make the door locking mechanism for vehicles to lock the vehicle.

Patent reference 1: JP,2002-269663,A

A problem with the above-mentioned related art security system for vehicles is however that since it starts a process of checking to see whether or not the vehicle is stolen when a main power supply for vehicles is turned on in response to a switching signal from an ignition switch, the related art security system cannot take measures against a case of starting the engine by directly wiring the ignition to a power supply without manipulating the ignition switch.

There have been provided requests to make it possible to cause the engine to start according to a special procedure even when the authorized vehicle user is not having the portable communication equipment, when the authorized vehicle user cannot use the portable communication equipment because the battery is dead or a failure occurs in the portable communication equipment, or when the ID information given to the portable communication equipment is changed because of replacement of the portable communication equipment with a new model of portable communication equipment. There have also been requests to perform registration and cancellation of the registration of the ID information of the portable communication equipment, and to make a change or the like to the ID information, with easy operations.

The present invention is made in order to solve the above-mentioned problems and to respond to the above-mentioned requests, and it is therefore an object of the present invention to provide an anti-theft system which can surely prevent any person other than an authorized vehicle user from starting the engine of a vehicle, thereby improving security against theft of the vehicle, and which makes it possible for the user to easily perform an operation for theft prevention.

### DISCLOSURE OF THE INVENTION

An anti-theft system in accordance with the present invention includes: an engine control unit for starting an engine in response to an on operation of an engine key only when an engine start enabling signal is supplied thereto; portable communication equipment which is used for short-distance wireless communications, and to which peculiar ID information is provided; and vehicle-mounted communication equipment having an ID information storage unit for registering the peculiar ID information provided to the portable communication equipment thereinto, for acquiring the ID information from the portable communication equipment via short-distance wireless communications regardless of whether the on operation of the engine key has been carried out, and for stopping the supply of the engine start enabling signal to the engine control unit when the acquired ID information does not match with the ID information registered into the ID information storage unit.

When the ID information acquired from the portable communication equipment via short-distance wireless communications does not match with the ID information registered into the ID information storage unit, the anti-theft system stops the supply of the engine start enabling signal to the engine control unit even if the on operation of the engine key is not carried out. Therefore, any parson who is not carrying the registered portable communication equipment cannot start the engine even if he or she tries to start the engine by directly wiring the ignition to a power supply without manipulating the engine key. As a result, the anti-theft system can prevent theft of the vehicle resulting from loss, theft, illegal duplication, or the like of the engine key, thereby improving security against theft of the vehicle.

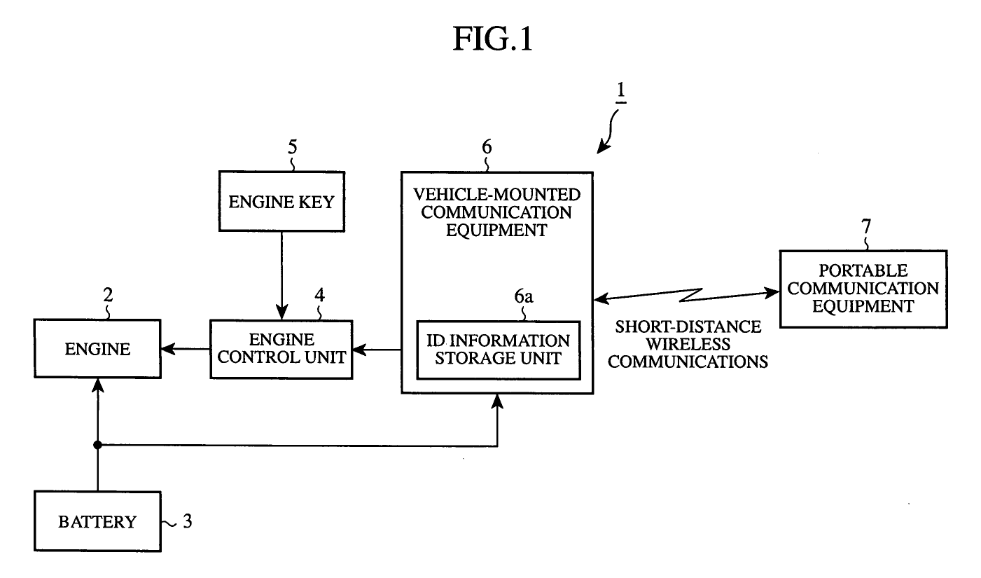

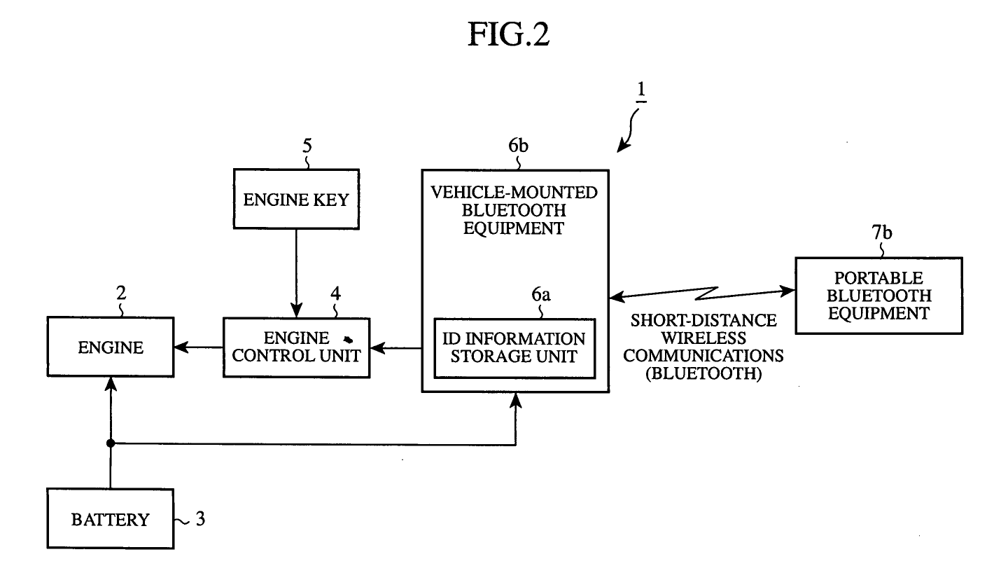

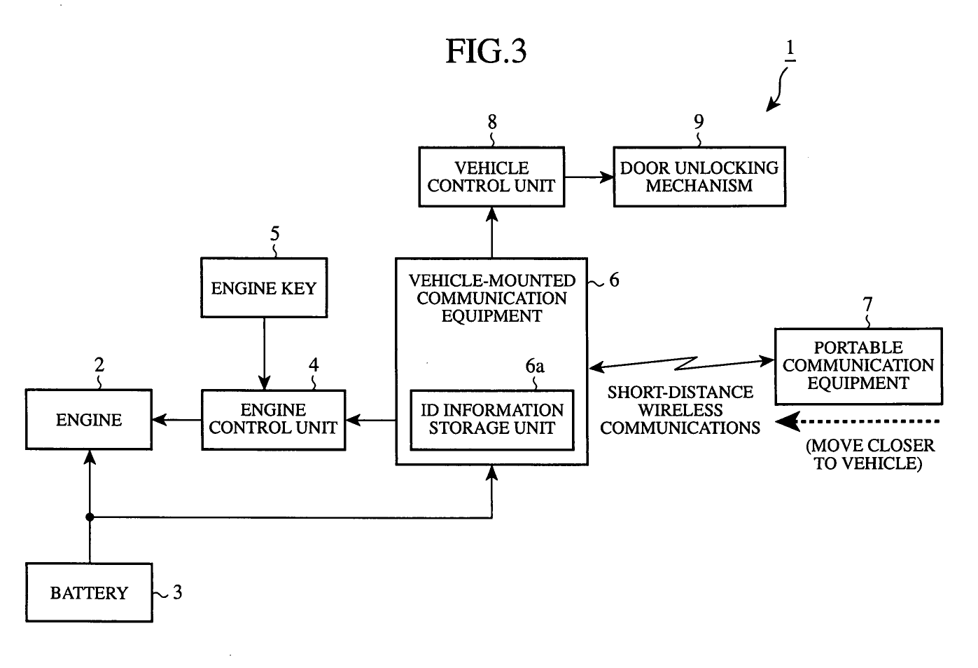

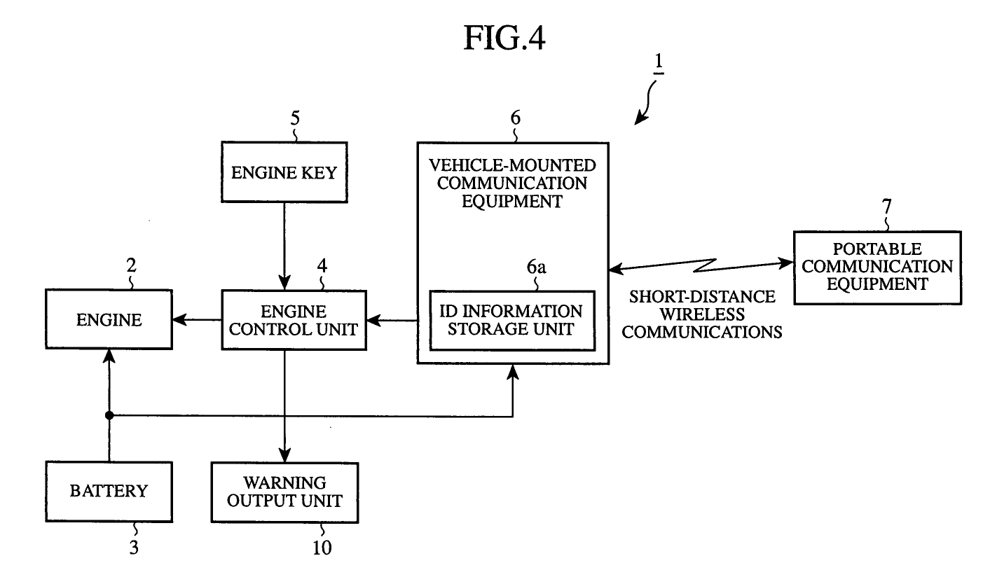

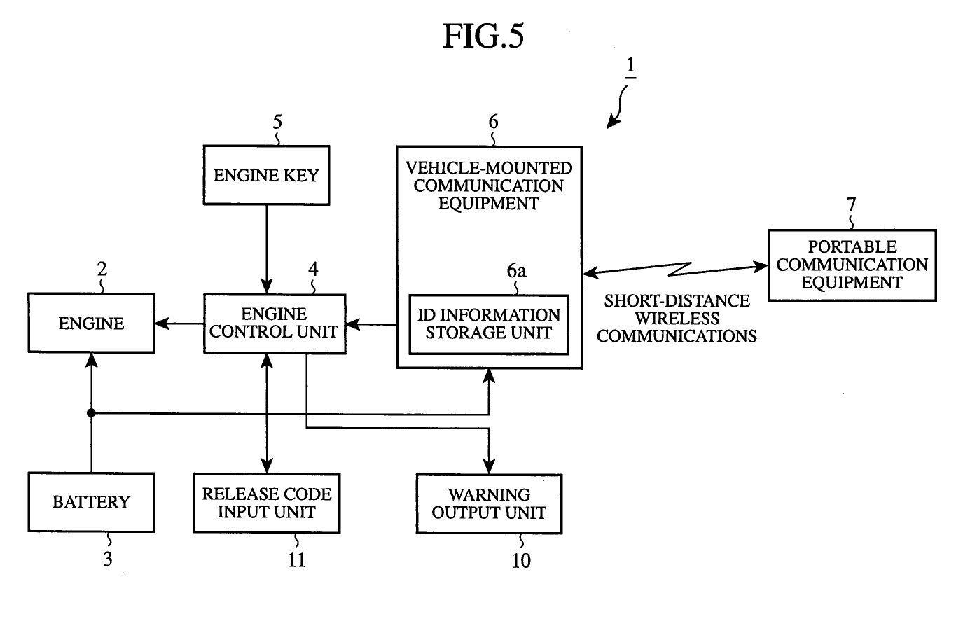

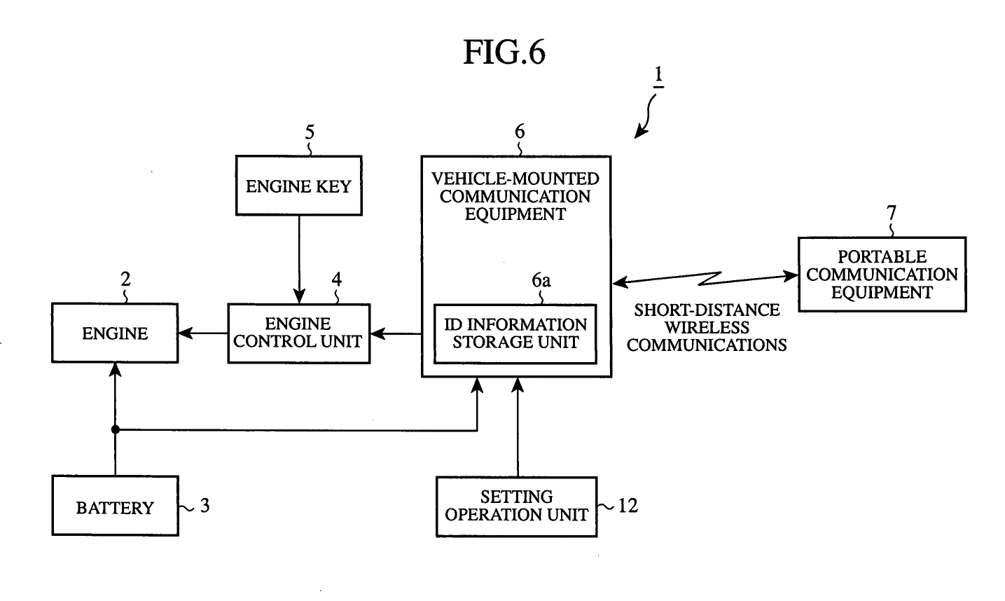

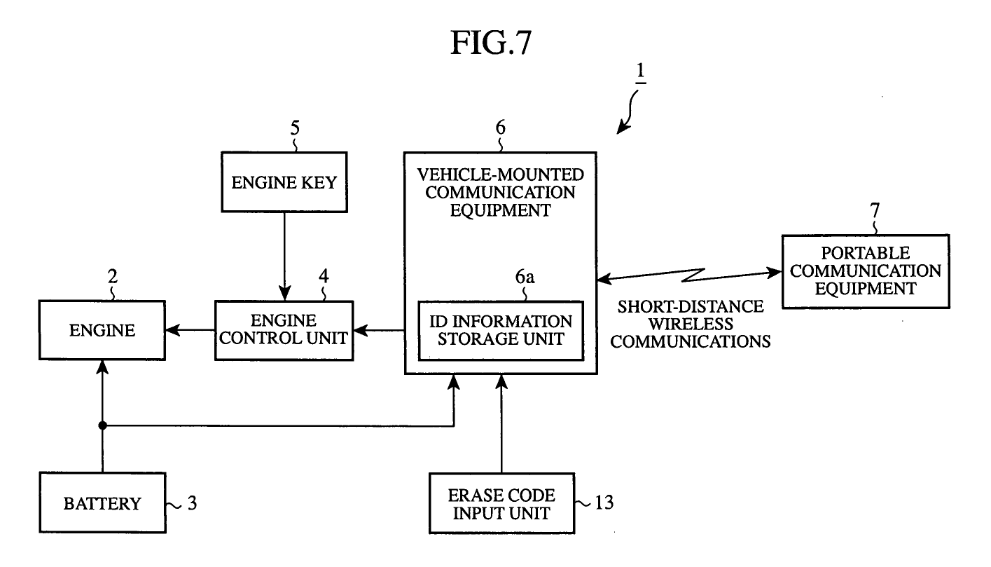

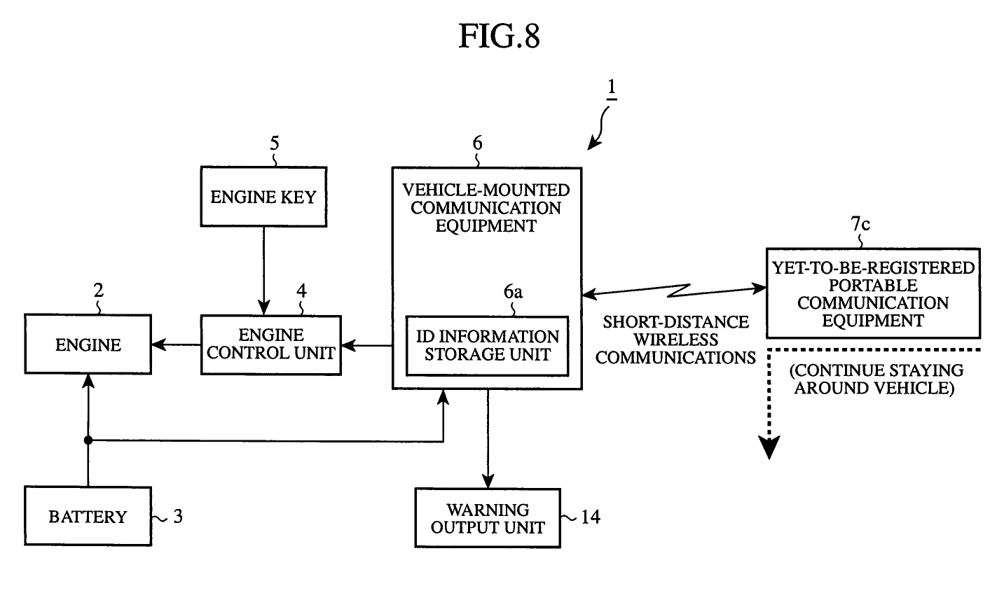

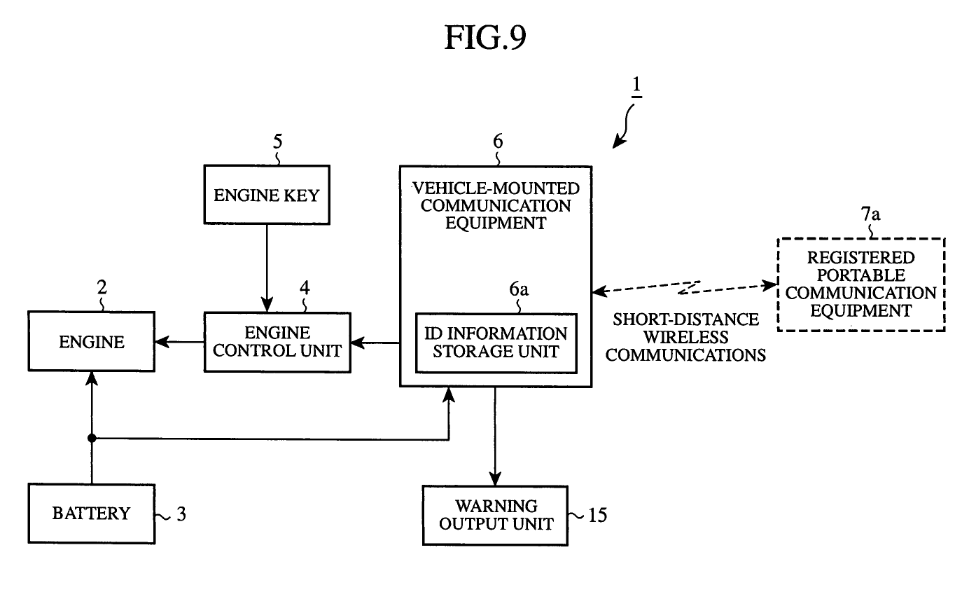

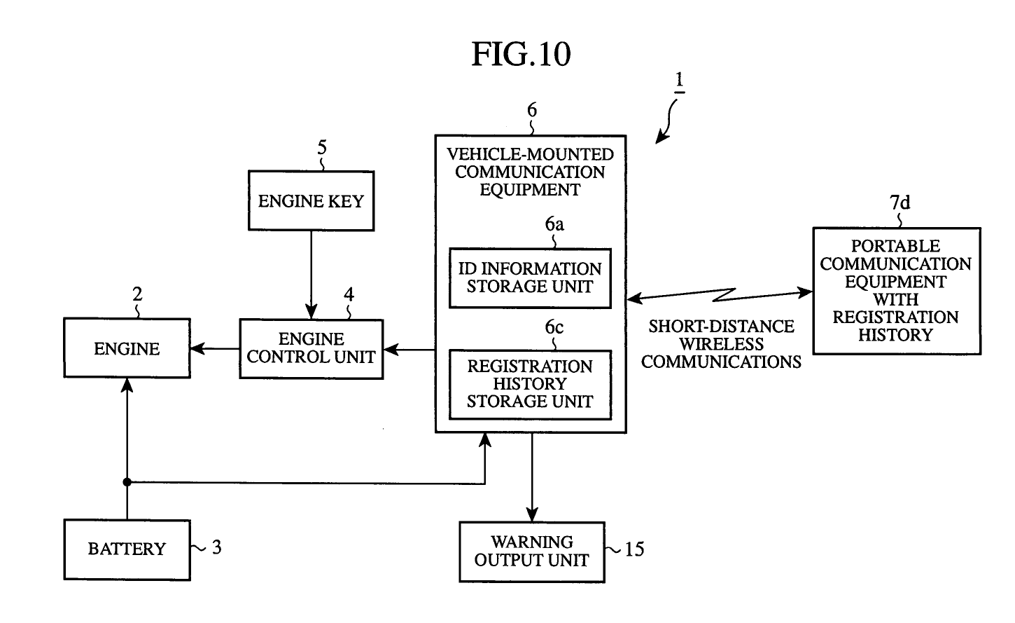

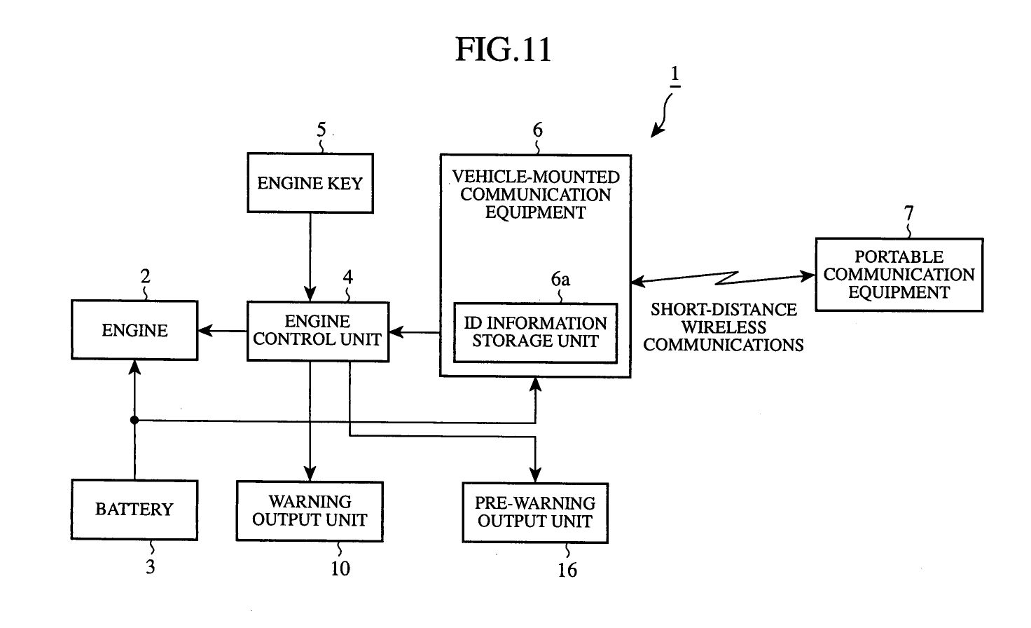

### BRIEF DESCRIPTION OF THE FIGURES

[FIG. 1] FIG. 1 is a block diagram showing the structure of an anti-theft system in accordance with embodiment 1 of the present invention;

[FIG. 2] FIG. 2 is a block diagram showing the structure of an anti-theft system in accordance with embodiment 2 of the present invention;

[FIG. 3] FIG. 3 is a block diagram showing the structure of an anti-theft system in accordance with embodiment 3 of the present invention;

[FIG. 4] FIG. 4 is a block diagram showing the structure of an anti-theft system in accordance with embodiment 4 of the present invention;

[FIG. 5] FIG. 5 is a block diagram showing the structure of an anti-theft system in accordance with any one of embodiments 5, 6, and 7 of the present invention;

[FIG. 6] FIG. 6 is a block diagram showing the structure of an anti-theft system in accordance with embodiment 8 of the present invention;

[FIG. 7] FIG. 7 is a block diagram showing the structure of an anti-theft system in accordance with any one of embodiments 9 and 10 of the present invention;

[FIG. 8] FIG. 8 is a block diagram showing the structure of an anti-theft system in accordance with embodiment 11 of the present invention;

[FIG. 9] FIG. 9 is a block diagram showing the structure of an anti-theft system in accordance with any one of embodiments 12 and 13 of the present invention;

[FIG. 10] FIG. 10 is a block diagram showing the structure of an anti-theft system in accordance with embodiment 14 of the present invention; and

[FIG. 11] FIG. 11 is a block diagram showing the structure of an anti-theft system in accordance with embodiment 15 of the present invention.

### PREFERRED EMBODIMENTS OF THE INVENTION

In order to explain the invention in greater detail, the preferred embodiments of the invention will be explained below with reference to the accompanying figures.

### Embodiment 1

FIG. 1 is a block diagram showing the structure of an anti-theft system in accordance with embodiment 1 of the present invention. This anti-theft system is provided with an engine 2, a battery 3, an engine control unit 4, an engine key 5, and vehicle-mounted communication equipment 6 which are mounted in a vehicle 1, and portable communication equipment 7 which an authorized vehicle user is having.

The start, stop, etc. of the engine 2 are controlled according to both a power source supplied thereto from the battery 3 and an engine control signal supplied from the engine control unit 4.

The engine control unit 4 generates the engine control signal based on both an instruction generated when the engine key 5 is manipulated and an engine start enabling signal sent thereto from the vehicle-mounted communication equipment 6, and sends them to the engine 2. To be more specific, the engine control unit 4 receives the instruction generated by the on operation of the engine key 5 so as to generate the engine control signal for starting the engine 2 only when the engine start enabling signal is sent thereto from the vehicle-mounted communication equipment 6. Therefore, the engine control unit ignores the on operation of the engine key 5 in a state in which the engine start enabling signal is not sent thereto from the vehicle-mounted communication equipment 6.

The vehicle-mounted communication equipment 6 is comprised of, for example, a car audio device having a short-distance wireless-communications function. This vehicle-mounted communication equipment 6 is provided with an ID information storage unit 6a. In order to enable the vehicle-mounted communication equipment to determine whether or not the communication partner is the portable communication equipment 7 which the authorized vehicle user is having, ID information uniquely given to the portable communication equipment 7 is registered (or memorized) into the ID information storage unit 6a. The car audio device is provided with two or more operation buttons (not shown) for controlling its audio function. These operation buttons are also used in order for the authorized vehicle user to register or erase the ID information, as will be mentioned later in detail. Instead of the car audio device, either a car navigation apparatus or another vehicle-mounted apparatus can be used as the vehicle-mounted communication equipment 6.

This vehicle-mounted communication equipment 6 runs from a power source (what is called +B power supply) supplied directly thereto from the battery 3. Therefore, even before the on operation of the engine key 5 is carried out, the vehicle-mounted communication equipment can operate. As an alternative, the power source can be directly supplied from the battery 3 not to the whole of the vehicle-mounted communication equipment 6, but only to a circuit of the vehicle-mounted communication equipment 6 for implementing a theft prevention function. According to this structure, the exhaustion of the battery 3 can be reduced compared with the case where the power source is supplied to the whole of the vehicle-mounted communication equipment 6.

For the short-distance wireless communications, electric waves in a 2.4 GHz band called the ISM band are used and a wireless LAN or a radio transmission system according to Bluetooth standards, which have been developed as short distance communication technologies that provide a transmission distance of about 10 to 100 meters and a transmission speed of about 1 to 11 Mbps, can be used.

The portable communication equipment 7 is comprised of a cellular phone provided with a short-distance wireless-communications function, and the ID information peculiar to this cellular phone is stored in the portable communication equipment 7. As the portable communication equipment 7, a transportable apparatus provided with a short-distance wireless-communications function, such as a PDA or a notebook personal computer, can be used instead of the cellular phone.

Next, the operation of the anti-theft system in accordance with embodiment 1 of the present invention which is constructed as mentioned above will be explained.

In a state in which the engine 2 is stopped, the vehicle-mounted communication equipment 6 to which the power source is supplied from the battery 3 is on standby while determining whether the portable communication equipment (referred to the “registered portable communication equipment” from here on) 7 having the ID information which matches with the ID information registered into the ID information storage unit 6a exists in a short-distance wireless communications area in which the registered portable communication equipment can carry out short-distance wireless communications with the vehicle-mounted communication equipment. To be more specific, the vehicle-mounted communication equipment 6 tries to acquire the ID information from the portable communication equipment 7 which exists in the short-distance wireless communications area at predetermined intervals. Then, when the user who is having the portable communication equipment 7 enters the vehicle 1, for example, the portable communication equipment 7 therefore enters the short-distance wireless communications area, and the vehicle-mounted communication equipment can acquire the ID information from the portable communication equipment 7, the vehicle-mounted communication equipment checks to see whether the acquired ID information matches with the ID information registered into the ID information storage unit 6a.

When determining that the ID information acquired from the portable communication equipment 7 matches with the ID information registered into the ID information storage unit 6a as the result of the checking, the vehicle-mounted communication equipment recognizes that the registered portable communication equipment 7 exists in the area in which it can carry out short-distance wireless communications with the vehicle-mounted communication equipment. The vehicle-mounted communication equipment 6 then sends the engine start enabling signal showing the fact to the engine control unit 4. In contrast, when determining that the ID information acquired from the portable communication equipment 7 does not match with the ID information registered into the ID information storage unit 6a, or when failing to acquire the ID information from the portable communication equipment 7, the vehicle-mounted communication equipment recognizes that the registered portable communication equipment 7 does not exist in the area in which it can carry out short-distance wireless communications with the vehicle-mounted communication equipment. In this case, the vehicle-mounted communication equipment 6 does not send any engine start enabling signal showing that the registered portable communication equipment can carry out short-distance wireless communications with the vehicle-mounted communication equipment to the engine control unit 4.

In response to the engine start enabling signal from the vehicle-mounted communication equipment 6, the engine control unit 4 enables the on operation of the engine key 5. Therefore, when receiving an instruction generated by the on operation of the engine key 5 in this state, the engine control unit generates the engine control signal for starting the engine 2 and sends it to the engine 2. The function of starting the engine 2 when the user who is having the registered portable communication equipment 7 turns on the engine key 5 is thus implemented.

On the other hand, the engine control unit 4 disables the on operation of the engine key 5 in a state in which it has not received the engine start enabling signal from the vehicle-mounted communication equipment 6. Therefore, even if the engine control unit 4 receives an instruction caused by the on operation of the engine key 5 in this state, it does not generate the engine control signal for starting the engine 2. The function of prohibiting the engine 2 from being started even if the on operation of the engine key 5 is performed by either a person who is not having the portable communication equipment 7 or a person who is having portable communication equipment 7 having ID information which is not registered into the ID information storage unit 6a of the vehicle-mounted communication equipment 6 is thus implemented.

As previously explained, the anti-theft system in accordance with embodiment 1 of the present invention controls whether to enable the on operation of the engine key 5 according to the engine start enabling signal from the vehicle-mounted communication equipment 6 to which the power source is always supplied, in contrast to a related art anti-theft system which starts a process of checking to see whether or not the vehicle is stolen in response to the on operation of the engine key 5 which is compliant with the vehicle 1. Therefore, even if a person who is not having the registered portable communication equipment 7 tries to start the engine without manipulating the engine key 5, e.g., by directly wiring the ignition to a power supply, he or she cannot start the engine 2. The present embodiment can thus protect the vehicle from theft resulting from the loss, theft, illegal duplication, or the like of the engine key 5, and therefore can improve security against theft of the vehicle.

### Embodiment 2

An anti-theft system in accordance with embodiment 2 of the present invention is so constructed as to carry out short-distance wireless communications using a radio transmission method compliant with the Bluetooth standards.

FIG. 2 is a block diagram showing the structure of a registration prevention system for vehicles in accordance with embodiment 2 of the present invention. This anti-theft system uses a vehicle-mounted Bluetooth (BT) device 6b provided with a Bluetooth interface instead of the vehicle-mounted communication equipment 6 of the anti-theft system in accordance with embodiment 1, and uses a portable Bluetooth (BT) device 7b provided with a Bluetooth interface instead of the portable communication equipment 7.

“BD_ADDR (a Bluetooth address)” which is defined according to the Bluetooth standards is used as ID information. The other structure of the anti-theft system of this embodiment is the same as that of the anti-theft system in accordance with embodiment 1. A Bluetooth address is uniquely assigned to every Bluetooth-mounted device. Therefore, when short-distance wireless communications are carried out using the radio transmission method compliant with the Bluetooth standards, since a Bluetooth address which is only one all over the world is used as ID information, the portable communication equipment 7 can be strictly distinguished form any other portable communication equipment.

The Bluetooth standards used in this anti-theft system have the following features.

(1) Electronic equipment which receives authentication according to the Bluetooth standards can carry out short-distance wireless communications regardless of the type (e.g., a personal computer, a cellular phone, a digital camera, or the like) and manufacturer of the electronic equipment.

(2) A unique number (BD_ADDR) is assigned to a control IC mounted in each electronic equipment.

(3) Each electronic equipment is wireless-connected to a master (MASTER) device while having a relationship between one of up to seven slave (SLAVE) devices and the master device.

(4) “Three sleep modes=which sometimes become search mode according to the standards=low power consumption mode” are defined.

(5) A procedure for exchanging information including “BD_ADDR” and “corresponding specifications”, and, after that, determining whether to establish a communication connection is adopted when establishing the communication connection. The master device is vested with the authority to determine whether to establish a communication connection.

According to the above-mentioned features of the Bluetooth standards, the anti-theft system in accordance with embodiment 2 defines the vehicle-mounted BT device 6b as “MASTER”, also defines the portable BT device 7b as “SLAVE”, and carries out short-distance wireless communications between the vehicle-mounted BT device 6b and the portable BT device 7b by using BD-ADDR as the ID information. The vehicle-mounted BT device 6b is set so as to operate in the sleep mode.

As previously explained, since the anti-theft system in accordance with embodiment 2 of the present invention uses the general-purpose Bluetooth standards as the radio transmission method of carrying out short-distance wireless communications. Therefore, low-cost components can be used as the components included in the anti-theft system, and the anti-bugging system can be formed at a low cost. Since the vehicle-mounted BT device 6b is so constructed as to operate in the sleep mode, the power consumption of the vehicle-mounted BT device 6b can be reduced, and this results in reduction in the exhaustion of the battery 3.

### Embodiment 3

An anti-theft system in accordance with embodiment 3 of the present invention includes a door unlocking function in addition to the structure of the anti-theft system in accordance with embodiment 1.

FIG. 3 is a block diagram showing the structure of the anti-theft system in accordance with embodiment 3 of the present invention. This anti-theft system has a modified function corresponding to that of the vehicle-mounted communication equipment 6 of the anti-theft system in accordance with embodiment 1, and additionally includes a vehicle control unit 8 and a door unlocking mechanism 9. Hereafter, the difference between this embodiment and embodiment 1 will be explained mainly.

The vehicle-mounted communication equipment 6 generates an engine start enabling signal and sends it to an engine control unit 4, as mentioned above, and also generates an unlocking enabling signal for permitting unlocking of doors of a vehicle 1 and sends it to the vehicle control unit 8. The unlocking enabling signal is generated on the same conditions as those on which the engine start enabling signal is generated.

The vehicle control unit 8 generates a door control signal in response to the unlocking enabling signal sent thereto from the vehicle-mounted communication equipment 6, and sends it to the door unlocking mechanism 9. The door unlocking mechanism 9 then unlocks the doors (not shown) in response to the door control signal sent thereto from the vehicle control unit 8.

Next, the operation of the anti-theft system in accordance with embodiment 3 of the present invention which is constructed as mentioned above will be explained.

In a state in which the engine 2 is stopped, the vehicle-mounted communication equipment 6 to which a power source is supplied from a battery 3 is on standby while determining whether registered portable communication equipment 7 exists in a short-distance wireless communications area in which the vehicle-mounted communication equipment can carry out short-distance wireless communications with the registered portable communication equipment, as concretely explained in the anti-theft system in accordance with embodiment 1.

When the registered portable communication equipment 7 exists in the short-distance wireless communications area in this standby state, the vehicle-mounted communication equipment 6 sends the unlocking enabling signal to the vehicle control unit 8 while sending the engine start enabling signal to the engine control unit 4. As a result, while the on operation of an engine key 5 is enabled, the door unlocking mechanism 9 operates so as to unlock the doors.

In contrast, when the registered portable communication equipment 7 does not exist in the short-distance wireless communications area in the above-mentioned standby state, the vehicle-mounted communication equipment 6 does not send the engine start enabling signal to the engine control unit 4, and does not send the unlocking enabling signal to the vehicle control unit 8, either. As a result, while the on operation of the engine key 5 is disabled, the door unlocking mechanism 9 does not operate and keeps the doors in the state where they are locked.

As previously explained, the anti-theft system in accordance with embodiment 3 of the present invention automatically unlocks the doors of the vehicle when a person having the registered portable communication equipment 7 enters an area in which the registered portable communication equipment 7 can carry out short-distance wireless communications with the vehicle-mounted communication equipment. Therefore, the unlocking operation becomes unnecessary. On the other hand, since the unlocking of the doors is not performed even when any person who is not having the registered portable communication equipment 7 enters the short-distance wireless communications area, the security against theft of the vehicle can be improved.

For example, when the registered portable communication equipment 7 exists in the owner's house and the vehicle 1 is parked in the garage of the house, if the portable communication equipment 7 exists in an area where it can carry out short-distance wireless communications with the vehicle 1 (i.e., the vehicle-mounted communication equipment 6), the doors of the vehicle may be unlocked unnecessarily. To solve this problem, the vehicle control unit 8 can be so constructed as to send only the door unlocking enabling signal to the door unlocking mechanism 9 in order to allow the user to actually and manually unlock the doors.

### Embodiment 4

An anti-theft system in accordance with embodiment 4 of the present invention has a function of outputting warning when an engine key 5 has been turned on two or more times in a state in which the operation of the engine key is disabled, in addition to the structure of the anti-theft system in accordance with embodiment 1.

FIG. 4 is a block diagram showing the structure of the anti-theft system in accordance with embodiment 4 of the present invention. This anti-theft system is so constructed as to have a modified function corresponding to that of the engine control unit 4 of the anti-theft system in accordance with embodiment 1, and to additionally include a warning output unit 10. Hereafter, the difference between this embodiment and embodiment 1 will be explained mainly.

When the on operation of the engine key 5 is carried out a predetermined number of times in a state in where no engine start enabling signal has been sent thereto from the vehicle-mounted communication equipment 6, the engine control unit 4 generates a warning control signal and sends it to the warning output unit 10.

The warning output unit 10 outputs warning with sound and/or light in response to the warning control signal from the engine control unit 4. The warning output unit 10 can consist of a speaker which outputs a sound, an LED which generates light, etc.

Next, the operation of the anti-theft system in accordance with embodiment 4 of the present invention which is constructed as mentioned above will be explained.

In a state in which an engine 2 is stopped, the vehicle-mounted communication equipment 6 to which a power source is supplied from a battery 3 is on standby while determining whether registered portable communication equipment 7 exists in a short-distance wireless communications area in which it can carry out short-distance wireless communications with the vehicle-mounted communication equipment, as concretely explained in the anti-theft system in accordance with embodiment 1.

When the registered portable communication equipment 7 exists in the short-distance wireless communications area in this standby state, the vehicle-mounted communication equipment 6 sends an engine start enabling signal to the engine control unit 4. As a result, the on operation of the engine key 5 is enabled.

In contrast, when the registered portable communication equipment 7 does not exist in the short-distance wireless communications area in the above-mentioned standby state, since the vehicle-mounted communication equipment 6 does not send the engine start enabling signal to the engine control unit 4, the on operation of the engine key 5 is disabled. In this state, when the on operation of the engine key 5 has been carried out two or more times, the engine control unit 4 generates a warning control signal and sends it to the warning output unit 10. As a result, the warning output unit 10 outputs warning with sound and/or light.

As explained above, since the anti-theft system in accordance with embodiment 4 of the present invention outputs warning when any person who is not carrying the registered portable communication equipment 7 has performed the on operation of the engine key 5 two or more times, security against theft of the vehicle can be improved.

The anti-theft system in accordance with this embodiment does not output any warning immediately after the on operation of the engine key 5 is performed, unlike related art anti-theft systems. In other words, the anti-theft system in accordance with this embodiment does not output any warning as long as the on operation of the engine key 5 is not carried out sequentially two or more times. Therefore, since any warning is not outputted even if the authorized vehicle user performs the on operation of the engine key 5 carelessly without carrying the registered portable communication equipment 7, the usability of the anti-theft system can be improved.

### Embodiment 5

An anti-theft system in accordance with embodiment 5 of the present invention has a function of enabling start of an engine under special conditions even if an authorized vehicle user is not having portable communication equipment 7 which is registered therein, in addition to the structure of the anti-theft system in accordance with embodiment 1.

FIG. 5 is a block diagram showing the structure of the anti-theft system in accordance with embodiment 5 of the present invention. This anti-theft system is so constructed as to have a modified function corresponding to that of the engine control unit 4 of the anti-theft system in accordance with embodiment 4, and to additionally include a release code input unit 11. Hereafter, the difference between this embodiment and embodiment 4 will be explained mainly.

The release code input unit 11 inputs a release code which is defined in advance. This release code inputted by the release code input unit 11 is sent to the engine control unit 4.

In a state in which no engine start enabling signal has been sent thereto from vehicle-mounted communication equipment 6, that is, even if a person having registered portable communication equipment 7 does not stay in an area in which it can carry out short-distance wireless communications with the vehicle-mounted communication equipment, the engine control unit 4 receives an instruction generated by the on operation of an engine key 5 and enables itself to start the engine when the release code is sent thereto from the release code input unit 1.

Next, the operation of the anti-theft system in accordance with embodiment 5 of the present invention which is constructed as mentioned above will be explained.

In a state in which the engine 2 is stopped, the vehicle-mounted communication equipment 6 to which a power source is supplied from a battery 3 is on standby while determining whether the registered portable communication equipment 7 exists in a short-distance wireless communications area in which it can carry out short-distance wireless communications with the vehicle-mounted communication equipment, as concretely explained in the anti-theft system in accordance with embodiment 1.

When the registered portable communication equipment 7 exists in the short-distance wireless communications area in this standby state, the vehicle-mounted communication equipment 6 sends the engine start enabling signal to the engine control unit 4. As a result, the on operation of the engine key 5 is enabled.

In contrast, when the registered portable communication equipment 7 does not exist in the short-distance wireless communications area in the above-mentioned standby state, the engine control unit 4 checks to see whether the release code has been sent thereto from the release code input unit 11, and, when determining that the release code has been sent thereto, enables the on operation of the engine key 5. On the other hand, when determining that the release code has not been sent thereto yet, the engine control unit 4 disables the on operation of the engine key 5. In this state where the on operation of the engine key 5 is disabled, when the on operation of the engine key 5 is sequentially carried out two or more times, the engine control unit 4 generates a warning control signal and sends it to the warning output unit 10. As a result, he warning output unit 10 outputs warning with sound and/or light.

As previously explained, the anti-theft system in accordance with embodiment 5 of the present invention allows even a person who is not having the registered portable communication equipment 7 to start the engine 2 when inputting the release code thereto using the release code input unit 11. Therefore, when the authorized vehicle user is going to drive the vehicle without carrying the registered portable communication equipment 7, the authorized vehicle user can drive the vehicle without receiving any warning from the anti-theft system.

This embodiment is useful for not only the case where the authorized vehicle user is going to drive the vehicle without carrying the registered portable communication equipment 7, but also a case where the battery of the portable communication equipment 7 is dead, or a failure occurs in the portable communication equipment 7. A predetermined time period during which the release code inputted from the release code input unit 11 is effective can be provided, and the engine 2 can be stopped when the predetermined time period elapses. This variant can improve security against theft of the vehicle.

### Embodiment 6

An anti-theft system in accordance with embodiment 6 of the present invention has a function of enabling the user to input a release code by using existing operation buttons of vehicle-mounted communication equipment 6, in addition to the structure of the anti-theft system in accordance with embodiment 5.

The structure of the anti-theft system in accordance with this embodiment 6 is the same as that of the anti-theft system in accordance with embodiment 5 shown in FIG. 5.

The vehicle-mounted communication equipment 6 is provided with two or more operation buttons not shown. A release code input unit 11 generates a release code in response to the operation of these operation buttons, and sends it to an engine control unit 4. When a car audio device is used as the vehicle-mounted communication equipment 6, preset memory buttons for presetting a radio station, which consists of number buttons “1” to “6”, are used as the operation buttons for inputting the release code.

In this case, a circuit for controlling the preset memory buttons of the car audio device can be so constructed as to run from a power source always supplied from the battery 3 of the vehicle 1, like the vehicle-mounted communication equipment 6.

As previously explained, the anti-theft system in accordance with embodiment 6 of the present invention uses the operation buttons which already exist in the vehicle-mounted communication equipment 6 as the release code input unit 11. Therefore, it is not necessary to dispose special operation buttons in the vehicle-mounted communication equipment 6, and the anti-theft system can be constructed at a low cost.

In order to enable the user to input the release code via the existing operation buttons, the power source from the battery 3 can be supplied not to the whole of the car audio device, but only to a minimum of circuitry required to control the preset memory buttons. In this case, the supply of power to the minimum of circuitry can be stopped when a predetermined time elapses after the power source has been supplied to the minimum of circuitry according to a predetermined operation and the release code is inputted by the operation of the operation buttons. According to this structure, since the power consumption can be further reduced when the release code input unit 11 is not used, the exhaustion of the battery 3 can be further reduced.

### Embodiment 7

An anti-theft system in accordance with embodiment 7 of the present invention has a function of outputting warning when an inaccurate release code (i.e., an unauthorized release code) has been input two or more times, in addition to the structure of the anti-theft system in accordance with embodiment 5.

The structure and operation of the anti-theft system in accordance with this embodiment 7 are the same as those of the anti-theft system in accordance with embodiment 5 shown in FIG. 5 except for the operation of an engine control unit 4. Hereafter, the difference between this embodiment and embodiment 5 will be explained mainly.

In a state in which no engine start enabling signal has been sent thereto from vehicle-mounted communication equipment 6, that is, when the owner having registered portable communication equipment 7 does not stay in an area where it can carry out short-distance wireless communications with the vehicle-mounted communication equipment, the engine control unit 4 generates a warning control signal and sends it to a warning output unit 10 when a release code different from the release code pre-stored in the engine control unit 4, i.e., an unauthorized release code has been sent thereto from a release code input unit 11 a predetermined number of times.

Next, the operation of the anti-theft system in accordance with embodiment 7 of the present invention which is constructed as mentioned above will be explained.

In a state in which an engine 2 is stopped, the vehicle-mounted communication equipment 6 to which a power source is supplied from a battery 3 is on standby while determining whether the registered portable communication equipment 7 exists in the short-distance wireless communications area in which it can carry out short-distance wireless communications with the vehicle-mounted communication equipment, as concretely explained in the anti-theft system in accordance with embodiment 1.

When the registered portable communication equipment 7 exists in the short-distance wireless communications area in this standby state, the vehicle-mounted communication equipment 6 sends the engine start enabling signal to the engine control unit 4. As a result, the on operation of the engine key 5 is enabled.

In contrast, when the registered portable communication equipment 7 does not exist in the short-distance wireless communications area in the above-mentioned standby state, the engine control unit 4 checks to see whether a release code has been sent thereto from the release code input unit 11. When then determining that a release code has been sent thereto, the engine control unit 4 checks to see whether or not the release code matches with the authorized release code. When determining that the release code sent thereto is not correct, i.e., it is an unauthorized release code, the engine control unit 4 checks to see whether a release code has been sent thereto from the release code input unit 11 again, and, when determining that a release code has been sent thereto, further checks to see whether or not the release code matches with the authorized release code.

After repeatedly performing the above-mentioned processing, when determining that an unauthorized release code has been sequentially sent thereto two or more times, the engine control unit 4 generates a warning control signal and sends it to the warning output unit 10. As a result, the warning output unit 10 outputs warning with sound and/or light. On the other hand, after repeatedly performing the above-mentioned processing, when determining that the authorized release code is sent thereto, the engine control unit 4 enables the on operation of the engine key 5.

As previously explained, the anti-theft system in accordance with embodiment 7 of the present invention can allow even a person who is not having the registered portable communication equipment 7 to start the engine 2 when inputting the release code thereto using the release code input unit 11, while outputting warning when an unauthorized release code has been input thereto two or more times, thereby improving security against theft of the vehicle.

### Embodiment 8

An anti-theft system in accordance with embodiment 8 of the present invention has a function of enabling the user to register the ID information of portable communication equipment 7 into vehicle-mounted communication equipment 6 only by performing an easy operation during a communication connection between the portable communication equipment and the vehicle-mounted communication equipment, in addition to the structure of the anti-theft system in accordance with embodiment 1.

FIG. 6 is a block diagram showing the structure of the anti-theft system in accordance with embodiment 8 of the present invention. This anti-theft system is so constructed as to have a modified function corresponding to that of the vehicle-mounted communication equipment 6 of the anti-theft system in accordance with embodiment 1, and to additionally include a setting operation unit 12. Hereafter, the difference between this embodiment and embodiment 1 will be explained mainly.

The setting operation unit 12 is used in order to provide an instruction for registering the ID information of the portable communication equipment 7 into an ID information storage unit 6a disposed in the vehicle-mounted communication equipment 6. In other words, the setting operation unit 12 generates a registration instruction in response to a manipulation thereof, and sends it to the vehicle-mounted communication equipment 6. When a car audio device is used as the vehicle-mounted communication equipment 6, operation buttons can be used as the setting operation unit 12.

In such an initial state as a state in which a vehicle 1 has been only recently purchased, the ID information of any portable communication equipment 7 is not registered into the ID information storage unit 6a of the vehicle-mounted communication equipment 6. In this initial state, the vehicle-mounted communication equipment 6 is set up so that it can establish a communication connection with any portable communication equipment 7.

Next, the operation of registering the ID information of desired portable communication equipment 7 into the vehicle-mounted communication equipment 6 in the anti-theft system in accordance with embodiment 8 of the present invention which is constructed as mentioned above will be explained.

When registering the ID information of desired portable communication equipment 7 into the ID information storage unit 6a of the vehicle-mounted communication equipment 6, synchronization with the desired portable communication equipment 7 is established, and a communication connection with the desired portable communication equipment 7 is then established in the state in which the vehicle-mounted communication equipment 6 is set up so that it can establish a communication connection with any portable communication equipment 7. When the setting operation unit 12 is manipulated in this state, the registration instruction is sent to the vehicle-mounted communication equipment 6. When receiving the registration instruction from the setting operation unit 12, the vehicle-mounted-communication equipment 6 acquires the ID information from the portable communication equipment 7, and then stores it in the ID information storage unit 6a. The process of registering the ID information of the desired portable communication equipment 7 into the vehicle-mounted communication equipment 6 is thus completed.

As previously explained, the anti-theft system in accordance with embodiment 8 of the present invention allows the user to register the ID information of portable communication equipment 7 into the vehicle-mounted communication equipment 6 by simply manipulating the setting operation unit 12 during a communication connection between the vehicle-mounted communication equipment 6 and the portable communication equipment 7.

### Embodiment 9

An anti-theft system in accordance with embodiment 9 of the present invention has a function of enabling the user to erase ID information registered into vehicle-mounted communication equipment 6, in addition to the structure of the anti-theft system in accordance with embodiment 1.

FIG. 7 is a block diagram showing the structure of the anti-theft system in accordance with embodiment 9 of the present invention. This anti-theft system is so constructed as to have a modified function corresponding to that of the vehicle-mounted communication equipment 6 of the anti-theft system in accordance with embodiment 1, and to additionally include an erase code input unit 13. Hereafter, the difference between this embodiment and embodiment 1 will be explained mainly.

The erase code input unit 13 is comprised of special-purpose keys, and is used in order for the user to input an erase code, which is defined in advance, into the system. The erase code inputted into the system by this erase code input unit 13 is sent to the vehicle-mounted communication equipment 6. For example, when a car audio device is used as the vehicle-mounted communication equipment 6, operation buttons of the car audio device can be used as the erase code input unit 13. In this case, since the special-purpose keys which serve as the erase code input unit become unnecessary, the anti-theft system can be constructed at a low cost.

In response to the erase code sent thereto from the erase code input unit 13, the vehicle-mounted communication equipment 6 erases the ID information stored in an ID information storage unit 6a.

Next, the operation of erasing the ID information registered into the vehicle-mounted communication equipment 6 in the anti-theft system in accordance with embodiment 9 of the present invention which is constructed as mentioned above will be explained.

When erasing the ID information registered into the ID information storage unit 6a of the vehicle-mounted communication equipment 6, the user causes the anti-theft system to shift to erasing mode by providing a predetermined instruction to the vehicle-mounted communication equipment 6 first. In this state, the user manipulates the erase code input unit 13 so as to input the erase code into the anti-theft system. This erase code inputted into the anti-theft system by the erase code input unit 13 is then sent to the vehicle-mounted communication equipment 6. In response to the erase code from the erase code input unit 13, the vehicle-mounted communication equipment 6 erases the ID information stored in the ID information storage unit 6a. When the process of erasing the ID information registered into the vehicle-mounted communication equipment 6 is thus completed, the vehicle-mounted communication equipment 6 is placed in the initial state.

As previously explained, the anti-theft system in accordance with embodiment 9 of the present invention erases the ID information registered into the vehicle-mounted communication equipment 6 in response to easy manipulation of the erase code input unit 13. Therefore, the ID information can be easily erased. In addition, since the anti-theft system returns to the initial state when the ID information registered into the vehicle-mounted communication equipment 6 is erased, conditions under which the ID information of other portable communication equipment 7 can be newly registered into the vehicle-mounted communication equipment are satisfied. The new registration of the ID information of portable communication equipment 7 can be implemented by the method explained in above-mentioned embodiment 8.

### Embodiment 10

An anti-theft system in accordance with embodiment 10 of the present invention has a function of enabling the user to erase ID information registered into vehicle-mounted communication equipment 6 only during a communication connection between the vehicle-mounted communication equipment and portable communication equipment, in addition to the structure of the anti-theft system in accordance with embodiment 9.

The structure and operation of the anti-theft system in accordance with this embodiment 7 are the same as those of the anti-theft system in accordance with embodiment 9 shown in FIG. 7 except for the operation of the vehicle-mounted communication equipment 6. Hereafter, the difference between this embodiment and embodiment 9 will be explained mainly.

In a state in which a communication connection is established between the vehicle-mounted communication equipment 6 and the portable communication equipment 7, the vehicle-mounted communication equipment 6 erases the ID information stored in an ID information storage unit 6a in response to an erase code sent thereto from an erase code input unit 13.

Next, the operation of erasing the ID information registered into the vehicle-mounted communication equipment 6 in the anti-theft system in accordance with embodiment 10 of the present invention which is constructed as mentioned above will be explained.

When erasing the ID information registered into the ID information storage unit 6a of the vehicle-mounted communication equipment 6, the user causes the anti-theft system to shift to erasing mode by providing a predetermined instruction to the vehicle-mounted communication equipment 6 first. In this state in which the anti-theft system is placed in the erasing mode, synchronization between the registered portable communication equipment 7 and the vehicle-mounted communication equipment 6 is established, and a communication connection between them is then established. In this state in which a communication connection is established between them, the user manipulates the erase code input unit 13 so as to input an erase code into the system. This erase code inputted into the system by the erase code input unit 13 is then sent to the vehicle-mounted communication equipment 6. In response to the erase code from the erase code input unit 13, the vehicle-mounted communication equipment 6 erases the ID information stored in the ID information storage unit 6a on conditions that a communication connection between the registered portable communication equipment 7 and the vehicle-mounted communication equipment 6 is established. The process of erasing the ID information registered into the vehicle-mounted communication equipment 6 is thus completed.

As previously explained, the anti-theft system in accordance with embodiment 10 of the present invention can erase the ID information registered into the vehicle-mounted communication equipment 6 only when the erase code is inputted from the erase code input unit 13 during a communication connection between the registered portable communication equipment 7 and the vehicle-mounted communication equipment 6. Therefore, the ID information cannot be erased even if a third party who is not having the registered portable communication equipment 7 causes the erase code input unit to input the erase code into the system. As a result, the anti-theft system in accordance with this embodiment can prevent any third party from erasing the ID information fraudulently.

### Embodiment 11

An anti-theft system in accordance with embodiment 11 of the present invention has a function of outputting warning when only yet-to-be-registered portable communication equipment which does not have ID information registered into the system continues staying in the vicinity of vehicle-mounted communication equipment 6 for a predetermined time period or more, in addition to the structure of the anti-theft system in accordance with embodiment 1.

FIG. 8 is a block diagram showing the structure of the anti-theft system in accordance with embodiment 11 of the present invention. This anti-theft system is so constructed as to have a modified function corresponding to that of the vehicle-mounted communication equipment 6 of the anti-theft system in accordance with embodiment 1, and to additionally include a warning output unit 14. Hereafter, the difference between this embodiment and embodiment 1 will be explained mainly.

When registered portable communication equipment 7 does not exist in an area where it can carry out short-distance wireless communications with the vehicle-mounted communication equipment 6 and yet-to-be-registered portable communication equipment 7c which does not have ID information registered into the system continues staying in the vicinity of the vehicle-mounted communication equipment 6 for a predetermined time period or more, the vehicle-mounted communication equipment 6 generates a warning control signal and sends it to the warning output unit 14.

The warning output unit 14 outputs warning with sound and/or light in response to the warning control signal from the vehicle-mounted communication equipment 6. The warning output unit 14 can consist of a speaker which outputs a sound, an LED which generates light, etc. This warning outputted from the warning output unit 14 can consist of such an announcement as “An anti-theft system is mounted in this vehicle”.

Next, the operation of the anti-theft system in accordance with embodiment 11 of the present invention which is constructed as mentioned above will be explained.

In a state in which an engine 2 is stopped, the vehicle-mounted communication equipment 6 to which a power source is supplied from a battery 3 is on standby while determining whether the registered portable communication equipment 7 exists in a short-distance wireless communications area in which it can carry out short-distance wireless communications with the vehicle-mounted communication equipment, as concretely explained in the anti-theft system in accordance with embodiment 1.

When the registered portable communication equipment 7 exists in the short-distance wireless communications area in this standby state, the vehicle-mounted communication equipment 6 sends an engine start enabling signal to an engine control unit 4. As a result, the on operation of an engine key 5 is enabled.

In contrast, when the registered portable communication equipment 7 does not exist in the short-distance wireless communications area and yet-to-be-registered portable communication equipment 7c continues staying in the vicinity of the vehicle-mounted communication equipment 6 for a predetermined time period or more, the vehicle-mounted communication equipment 6 generates the warning control signal and sends it to the warning output unit 14. As a result, the warning output unit 14 outputs warning with sound and/or light.

As previously explained, the anti-theft system in accordance with embodiment 11 of the present invention outputs warning when a person who is not carrying the registered portable communication equipment 7 continues staying in the vicinity of the vehicle 1 (i.e., the vehicle-mounted communication equipment 6) for a predetermined time period or more. Therefore, the anti-theft system can protect the vehicle from illegal acts (e.g., prevent the vehicle from being ransacked) by a third party, thereby improving the security.

The anti-theft system can be so constructed as to select, as the time of outputting warning, “only at designated times”, “only at night”, or the like. According to this structure, the anti-theft system can deal with a case where the user desires to disable the function of outputting warning.

### Embodiment 12

An anti-theft system in accordance with embodiment 12 of the present invention has a function of checking to see whether vehicle-mounted communication equipment can carry out communications with registered portable communication equipment 7 at predetermined intervals while a vehicle 1 is moving, and outputting warning when determining that the vehicle-mounted communication equipment cannot carry out communications with the registered portable communication equipment 7, in addition to the structure of the anti-theft system in accordance with embodiment 1.

FIG. 9 is a block diagram showing the structure of the anti-theft system in accordance with embodiment 12 of the present invention. This anti-theft system is so constructed as to have a modified function corresponding to that of the vehicle-mounted communication equipment 6 of the anti-theft system in accordance with embodiment 1, and to additionally include a warning output unit 15. Hereafter, the difference between this embodiment and embodiment 1 will be explained mainly.

The vehicle-mounted communication equipment 6 checks to see whether it can carry out communications with the registered portable communication equipment 7 at predetermined intervals while the vehicle 1 is moving, and generates and outputs a warning control signal to the warning output unit 14 when determining that the vehicle-mounted communication equipment cannot carry out communications with the registered portable communication equipment 7. The anti-theft system determines whether or not the vehicle 1 is moving based on a speed signal acquired from a speed sensor not shown.

The warning output unit 15 outputs warning with sound and/or light in response to the warning control signal from the vehicle-mounted communication equipment 6. The warning output unit 14 can consist of a speaker which outputs a sound, an LED which generates light, etc. This warning outputted from the warning output unit 14 can consist of an announcement “This is a stolen car”, a blast of a horn, or the like.

Next, the operation of the anti-theft system in accordance with embodiment 12 of the present invention which is constructed as mentioned above will be explained.

In a state in which an engine 2 has been started, the vehicle-mounted communication equipment 6 is on standby while determining whether the registered portable communication equipment 7 exists in a short-distance wireless communications area in which it can carry out short-distance wireless communications with the vehicle-mounted communication equipment. When determining that the vehicle 1 is moving in this standby state, the vehicle-mounted communication equipment 6 checks to see whether it can carry out communications with the registered portable communication equipment 7.

When, in the above-mentioned checking step, determining that it is impossible to carry out communications with the registered portable communication equipment 7, the vehicle-mounted communication equipment 6 generates a warning control signal, and sends it to the warning output unit 14. As a result, the warning output unit outputs warning with sound and/or light.

As previously explained, the anti-theft system in accordance with embodiment 12 of the present invention outputs warning when a person who is not carrying the registered portable communication equipment 7 has driven the vehicle 1 (i.e., the vehicle-mounted communication equipment 6). Therefore, when the driver leaves from the vehicle 1 temporarily while having the registered portable communication equipment 7 with the engine at an idle, and the vehicle is then stolen, for example, the anti-theft system makes an announcement “This is a stolen car”, or blasts a horn if the vehicle 1 moves, so as to notify those around-the moving vehicle that the vehicle has been stolen.

### Embodiment 13

An anti-theft system in accordance with embodiment 12 of the present invention has a function of checking to see whether vehicle-mounted communication equipment can carry out communications with registered portable communication equipment 7 at predetermined intervals while a vehicle 1 is moving, and outputting warning when determining that the state in which the vehicle-mounted communication equipment cannot carry out communications with the registered portable communication equipment 7 has lasted for a predetermined time period or more, in addition to the structure of the anti-theft system in accordance with embodiment 12.

The structure and operation of the anti-theft system in accordance with this embodiment 13 are the same as those of the anti-theft system in accordance with embodiment 12 shown in FIG. 9 except for the operation of the vehicle-mounted communication equipment 6. Hereafter, the difference between this embodiment and embodiment 12 will be explained mainly.

While the vehicle 1 is moving, the vehicle-mounted communication equipment 6 checks to see whether it can carry out communications with the registered portable communication equipment 7, and, when determining that the state in which the vehicle-mounted communication equipment cannot carry out communications with the registered portable communication equipment 7 has lasted for a predetermined time period or more, generates a warning control signal and sends it to a warning output unit 14.

Next, the operation of the anti-theft system in accordance with embodiment 13 of the present invention which is constructed as mentioned above will be explained.

In a state in which an engine 2 has been started, the vehicle-mounted communication equipment 6 is on standby while determining whether the registered portable communication equipment 7 exists in a short-distance wireless communications area in which it can carry out short-distance wireless communications with the vehicle-mounted communication equipment. When determining that the vehicle 1 is moving in this standby state, the vehicle-mounted communication equipment 6 checks to see whether it can carry out communications with the registered portable communication equipment 7.

When, in the above-mentioned checking step, determining that it is impossible to carry out communications with the registered portable communication equipment 7, the vehicle-mounted communication equipment 6 checks to see whether the state in which it is impossible to carry out communications with the registered portable communication equipment has lasted for the predetermined time period or more. When then determining that the state in which it is impossible to carry out communications with the registered portable communication equipment has lasted for the predetermined time period or more, the vehicle-mounted communication equipment generates the warning control signal and sends it to the warning output unit 14. As a result, the warning output unit outputs warning with sound and/or light.

As previously explained, the anti-theft system in accordance with embodiment 13 of the present invention outputs warning when a person who is not carrying the registered portable communication equipment 7 has driven the vehicle 1 (i.e., the vehicle-mounted communication equipment 6), that is, when a state in which the registered portable communication equipment 7 is not moving together with the vehicle 1 has lasted for a predetermined time period. Therefore, as previously explained in embodiment 5, when the authorized vehicle user brings the vehicle to a state in which the user can drive the vehicle by inputting a release code into the anti-theft system without having the portable communication equipment 7, for example, the anti-theft system does not output any warning within the predetermined time period. Accordingly, in such a case as “a bit of shopping” in neighboring stores, since the user doesn't need to carry the registered portable communication equipment 7, the anti-theft system affords convenience to the user.

### Embodiment 14

An anti-theft system in accordance with embodiment 14 of the present invention has a function of outputting no warning when vehicle-mounted communication equipment can carry out communications with portable communication equipment (referred to as portable communication equipment with registration history) which was registered in the past into the anti-theft system while the vehicle-mounted communication equipment cannot carry out communications with registered portable communication equipment 7, in addition to the structure of the anti-theft system in accordance with embodiment 13.

FIG. 10 is a block diagram showing the structure of the anti-theft system in accordance with embodiment 14 of the present invention. This anti-theft system is so constructed as to have a modified function corresponding to that of the vehicle-mounted communication equipment 6 of the anti-theft system in accordance with embodiment 1, and to additionally include a warning output unit 15. Hereafter, the difference between this embodiment and embodiment 1 will be explained mainly.

The vehicle-mounted communication equipment 6 is provided with a registration history storage unit 6c for storing ID information which was stored in the past in an ID information storage unit 6a. The vehicle-mounted communication equipment 6 checks to see whether it can carry out communications with the registered portable communication equipment 7 while the vehicle 1 is moving, and, when determining that it cannot carry out communications with the registered portable communication equipment 7, further checks to see whether it can carry out communications with any portable communication equipment with registration history 7d having ID information which is stored in the registration history storage unit 6c. When determining that it is impossible to carry out communications with any portable communication equipment with registration history 7d, the vehicle-mounted communication equipment generates a warning control signal and sends it to the warning output unit 14. The anti-theft system determines whether or not the vehicle 1 is moving based on a speed signal acquired from a speed sensor not shown. The warning output unit 15 operates in the same way that that of embodiment 12 does.

Next, the operation of the anti-theft system in accordance with embodiment 14 of the present invention which is constructed as mentioned above will be explained.

In a state in which an engine 2 has been started, the vehicle-mounted communication equipment 6 is on standby while determining whether the registered portable communication equipment 7 exists in a short-distance wireless communications area in which it can carry out short-distance wireless communications with the vehicle-mounted communication equipment. When determining that the vehicle 1 is moving in this standby state, the vehicle-mounted communication equipment 6 checks to see whether it can carry out communications with the registered portable communication equipment 7.

When, in the above-mentioned checking step, determining that it is impossible to carry out communications with the registered portable communication equipment 7, the vehicle-mounted communication equipment 6 further checks to see whether it can carry out communications with any portable communication equipment with registration history 7d having ID information which is stored in the registration history storage unit 6c. When determining that it is impossible to carry out communications with any portable communication equipment with registration history 7d, the vehicle-mounted communication equipment generates a warning control signal and sends it to the warning output unit 14. As a result, the warning output unit outputs warning with sound and/or light.

As previously explained, the anti-theft system in accordance with embodiment 14 of the present invention can avoid the output of warning when the user is carrying other portable communication equipment which was registered in the past into the anti-theft system after, for example, replacing the registered portable communication equipment registering with another family member's portable communication equipment.

### Embodiment 15

An anti-theft system in accordance with embodiment 15 of the present invention has a function of outputting pre-warning before outputting warning, in addition to the structure of the anti-theft system in accordance with embodiment 4.

FIG. 11 is a block diagram showing the structure of the anti-theft system in accordance with embodiment 15 of the present invention. This anti-theft system is so constructed as to include a pre-warning output unit 16 in addition to the structure of the anti-theft system in accordance with embodiment 14. Hereafter, the difference between this embodiment and embodiment 4 will be explained mainly.

In a state in which no engine start enabling signal has been sent thereto from vehicle-mounted communication equipment 6, an engine control unit 4 generates a pre-warning control signal and sends it to the pre-warning output unit 16 when the on operation of an engine key 5 is carried out.

The pre-warning output unit 16 outputs pre-warning with sound and/or light in response to the pre-warning control signal from the engine control unit 4. The pre-warning output unit 16 can consist of a speaker which outputs a sound, an LED which generates light, etc.

Next, the operation of the anti-theft system in accordance with embodiment 4 of the present invention which is constructed as mentioned above will be explained.

In a state in which an engine 2 is stopped, the vehicle-mounted communication equipment 6 to which a power source is supplied from a battery 3 is on standby while determining whether registered portable communication equipment 7 exists in a short-distance wireless communications area in which it can carry out short-distance wireless communications with the vehicle-mounted communication equipment, as concretely explained in the anti-theft system in accordance with embodiment 1.

When the registered portable communication equipment 7 exists in the short-distance wireless communications area in this standby state, the vehicle-mounted communication equipment 6 sends the engine start enabling signal to the engine control unit 4. As a result, the on operation of the engine key 5 is enabled.

In contrast, when the registered portable communication equipment 7 does not exist in the short-distance wireless communications area in the above-mentioned standby state, since the vehicle-mounted communication equipment 6 does not send the engine start enabling signal to the engine control unit 4, the on operation of the engine key 5 is disabled. In this state, when the on operation of the engine key 5 is carried out, the engine control unit 4 generates a pre-warning control signal and sends it to the pre-warning output unit 16. As a result, the pre-warning output unit outputs pre-warning such as an announcement “Stop the illegal act immediately”, for example.

After that, when the on operation of the engine key 5 is carried out a predetermined number of times, the engine control unit 4 generates a warning control signal and sends it to the warning output unit 10. As a result, the warning output unit outputs warning which is conspicuous for those around the vehicle, by, for example, blasting a horn.

As previously explained, the anti-theft system in accordance with embodiment 15 of the present invention outputs warning after outputting pre-warning. There is a possibility that sudden warning, such as a blast of a horn, or notification of an announcement “This car is stolen” to those around the vehicle, confuses the driver and hence interferes with safe driving. In contrast, the stepwise warning output process including the step of outputting pre-warning and the step of outputting warning can avoid such a situation. By performing the step of outputting pre-warning with such an announcement as “This car has theft prevention function” or “You are doing illegal act”, the rate of theft prevention can be raised and the security against theft of the vehicle can be improved.

The function of outputting pre-warning before outputting warning can be also applied to the anti-theft system which outputs warning in accordance with any one of above-mentioned embodiments 7, 11, 12, 13, and 14.

### INDUSTRIAL APPLICABILITY

As mentioned above, the anti-theft system in accordance with the present invention is suitable for surely preventing any person other than an authorized vehicle user from starting the engine of a vehicle and making it possible to take measures against theft of the vehicle with an easy operation.

1. An anti-theft system comprising:
an engine control unit for starting an engine in response to an on operation of an engine key only when an engine start enabling signal is supplied thereto;
portable communication equipment which is used for short-distance wireless communications, and to which peculiar ID information is provided; and
vehicle-mounted communication equipment having an ID information storage unit for registering the peculiar ID information provided to said portable communication equipment thereinto, for acquiring the ID information from said portable communication equipment via short-distance wireless communications regardless of whether the on operation of said engine key has been carried out, and for stopping the supply of said engine start enabling signal to said engine control unit when the acquired ID information does not match with the ID information registered into said ID information storage unit.

2. The anti-theft system according to claim 1, characterized in that the short-distance wireless communications are carried out using a radio transmission method according to Bluetooth standards.

3. The anti-theft system according to claim 1, characterized in that said system further includes a vehicle control unit for unlocking a door of the vehicle in response to an unlocking enabling signal for allowing unlocking of the door, and said vehicle-mounted communication equipment supplies said unlocking enabling signal to said vehicle control unit when ID information which matches with the ID information acquired from said portable communication equipment via short-distance wireless communications is registered into the ID information storage unit.

4. The anti-theft system according to claim 1, characterized in that the engine control unit also generates a warning output when the on operation of the engine key is carried out two or more times in a state in which the ID information acquired from the portable communication equipment via short-distance wireless communications does not match with the ID information registered into the ID information storage unit.

5. The anti-theft system according to claim 1, characterized in that said system further includes a release code input unit for inputting a release code into the engine control unit, and said engine control unit starts the engine in response to the on operation of the engine key when the release code is inputted thereto from said release code input unit even if said engine control unit is placed in a state in which the engine start enabling signal is not supplied thereto.

6. The anti-theft system according to claim 5, characterized in that existing operation buttons of the vehicle-mounted communication equipment are used as the release code input unit, and the release code input unit generates the release code according to a manipulation of said operation buttons and sends the release code to the engine control unit.

7. The anti-theft system according to claim 5, characterized in that the engine control unit generates a warning output when an unauthorized release code is sequentially input thereto from the release code input unit two or more times.

8. The anti-theft system according to claim 1, characterized in that the vehicle-mounted communication equipment has an operation button, and acquires ID information from the portable communication equipment and registers the ID information into the ID information storage unit when said operation button is manipulated in a state in which the vehicle-mounted communication equipment carries out short-distance wireless communications with the portable communication equipment.

9. The anti-theft system according to claim 1, characterized in that said system further includes an erase code input unit for inputting an erase code into the vehicle-mounted communication equipment, and said vehicle-mounted communication equipment erases the ID information stored in the ID information storage unit in response to the erase code inputted from said erase code input unit.

10. The anti-theft system according to claim 9, characterized in that the vehicle-mounted communication equipment erases the ID information stored in the ID information storage unit in response to the erase code from the erase code input unit only when the vehicle-mounted communication equipment is placed in a state in which it carries out short-distance wireless communications with the portable communication equipment.

11. The anti-theft system according to claim 1, characterized in that the vehicle-mounted communication equipment generates a warning output when only portable communication equipment other than the portable communication equipment having the ID information registered into the ID information storage unit exists in an area in which it can carry out short-distance wireless communications with the vehicle-mounted communication equipment for a predetermined time period or more.

12. The anti-theft system according to claim 1, characterized in that the vehicle-mounted communication equipment generates a warning output when the portable communication equipment having the ID information registered into the ID information storage unit is not moving together with the vehicle.

13. The anti-theft system according to claim 1, characterized in that the vehicle-mounted communication equipment generates a warning output when a state in which the portable communication equipment having the ID information registered into the ID information storage unit is not moving together with the vehicle lasts for a predetermined time period.

14. The anti-theft system according to claim 1, characterized in that the vehicle-mounted communication equipment generates a warning output when portable communication equipment having ID information which has not been registered into the ID information storage unit yet is moving together with the vehicle.

15. The anti-theft system according to claim 4, characterized in that the vehicle-mounted communication equipment generates a pre-warning output before generating the warning output.
